(19) United States
(12) Patent Application Publication
(10) Pub. No.: US 2016/0276823 A1
(43) Pub. Date: Sep. 22, 2016

(54) POWER SUPPLY SYSTEM

(71) Applicant: Toyota Jidosha Kabushiki Kaisha, Toyota-shi Aichi-ken (JP)

(72) Inventors: Takahiro Himeno, Toyota-shi (JP); Tomoko Oba, Nagoya-shi Aichi-ken (JP)

(21) Appl. No.: 15/073,051

(22) Filed: Mar. 17, 2016

(30) Foreign Application Priority Data
Mar. 20, 2015 (JP) 2015-058563

(51) Int. Cl. H02H 3/087; H02J 1/00; H02J 1/10

(52) U.S. Cl. CPC H02H 3/087; H02J 1/10; H02J 1/00

(57) ABSTRACT

A chip set is configured such that a first overcurrent signal that is output at the time when there is an overcurrent in a first semiconductor switch or a third semiconductor switch and a second overcurrent signal that is output at the time when there is an overcurrent in a second semiconductor switch or a fourth semiconductor switch are input to input ports of an arithmetic processing unit.

### INCORPORATION BY REFERENCE

The disclosure of Japanese Patent Application No. 2015-058563 filed on Mar. 20, 2015 including the specification, drawings and abstract is incorporated herein by reference in its entirety.

### BACKGROUND OF THE INVENTION

1. Field of the Invention

The invention relates to a power supply system that includes two direct-current power supplies and that is able to selectively connect these direct-current power supplies in series with or in parallel with a load circuit.

2. Description of Related Art

Japanese Patent Application Publication No. 2013-93923 (JP 2013-93923 A) describes a power supply system (hereinafter, also referred to as existing system) that includes two direct-current power supplies, four semiconductor switches, two reactors and a control unit that switches each of the four semiconductor switches between a conductive state and an interrupted state. In the existing system, a parallel connection mode is executed. In the parallel connection mode, a load circuit is supplied with electric power in a state where the two direct-current power supplies are connected in parallel with each other by keeping a specific one of the four semiconductor switches in the conductive state (on state). Furthermore, in the existing system, a series connection mode is executed. In the series connection mode, the load circuit is supplied with electric power in a state where the two direct-current power supplies are connected in series with each other by keeping another one of the four semiconductor switches in the conductive state.

In addition, the existing system switches the semiconductor switches, which are not kept in the conductive state among the four semiconductor switches, between the conductive state and the interrupted state (off state) to control energy that is stored in the reactors, thus making it possible to step up the output voltage of the two direct-current power supplies and apply the stepped-up voltage to the load circuit.

For example, the control unit executes the parallel connection mode when a voltage that is required of the load circuit (required voltage) is low, and executes the series connection mode when the required voltage is high. More specifically, the control unit executes the parallel connection mode when the required voltage is lower than the sum of the terminal voltages of the two direct-current power supplies. On the other hand, the control unit executes the series connection mode when the required voltage is higher than the sum of the terminal voltages of the two direct-current power supplies.

Incidentally, when any one of the semiconductor switches fails and is not able to perform switching operation in the conductive state (hereinafter, also referred to as short-circuit failure), and when another one of the semiconductor switches is controlled to the conductive state, a closed circuit is established, and excessive current can flow through the semiconductor switches, the direct-current power supplies, and the like. There is a concern that these devices are damaged due to occurrence of an overcurrent.

In order to detect occurrence of an overcurrent, there is a case where each of the four semiconductor switches includes an overcurrent detection unit. When occurrence of an overcurrent has been detected by any one of the overcurrent detection units, the control unit controls each of the four semiconductor switches to the interrupted state. Thus, occurrence of an overcurrent is eliminated, so it is possible to avoid occurrence of damage to the devices.

For example, when output signals of the four overcurrent detection units are respectively connected to input ports of an arithmetic processing unit (for example, a CPU or an MCU) of the control unit in order for the control unit to detect occurrence of an overcurrent, the four input ports of the arithmetic processing unit are used. However, using an arithmetic processing unit including a large number of input ports leads to an increase in manufacturing cost of a power supply system, so it is desirable to suppress the number of input ports that are used in order to detect occurrence of an overcurrent.

### SUMMARY OF THE INVENTION

The invention provides a power supply system that is able to detect occurrence of an overcurrent in the event of occurrence of an overcurrent and control semiconductor switches in an interrupted state while suppressing the number of input ports of an arithmetic processing unit of a control unit, which is used in order to detect occurrence of an overcurrent.

An aspect of the invention provides a power supply system (hereinafter, also referred to as the system according to the invention) includes a positive electrode connection point, a negative electrode connection point, a specific power supply line, a first direct-current power supply and a second direct-current power supply. A load circuit is connected to the positive electrode connection point and the negative electrode connection point. The positive electrode connection point and the negative electrode connection point are used to supply direct-current power to the load circuit. The system according to the invention further includes a first diode to a fourth diode, a first semiconductor switch to a fourth semiconductor switch, and an electronic control unit.

The specific power supply line connects the positive electrode connection point with the negative electrode connection point. The specific power supply line includes a first connection point located between the positive electrode connection point and the negative electrode connection point, a second connection point located between the first connection point and the negative electrode connection point, a third connection point located between the second connection point and the negative electrode connection point, and a fourth connection point located between the third connection point and the negative electrode connection point.

A positive electrode of the first direct-current power supply is connected to the first connection point, and a negative electrode of the first direct-current power supply is connected to the third connection point. A positive electrode of the second direct-current power supply is connected to the second connection point, and a negative electrode of the second direct-current power supply is connected to the fourth connection point.

The first diode is interposed in a portion of the specific power supply line between the positive electrode connection point and the first connection point, a cathode of the first diode is on the positive electrode connection point side, and an anode of the first diode is on the first connection point side. The second diode is interposed in a portion of the specific power supply line between the first connection point and the second connection point, a cathode of the second diode is on the first connection point side, and an anode of the second diode is on the second connection point side.

The third diode is interposed in a portion of the specific power supply line between the second connection point and the third connection point, a cathode of the third diode is on the second connection point side, and an anode of the third diode is on the third connection point side. The fourth diode is interposed in a portion of the specific power supply line between the third connection point and the fourth connection point, a cathode of the fourth diode is on the third connection point side, and an anode of the fourth diode is on the fourth connection point side.

The first semiconductor switch is connected in antiparallel with the first diode. The second semiconductor switch is connected in antiparallel with the second diode. The third semiconductor switch is connected in antiparallel with the third diode. The fourth semiconductor switch is connected in antiparallel with the fourth diode. Each of the first semiconductor switch to the fourth semiconductor switch includes an overcurrent detection unit configured to output a detection signal when the overcurrent detection unit has detected overcurrent flowing through a corresponding one of the first semiconductor switch to the fourth semiconductor switch.

The electronic control unit is configured to selectively execute any one of a parallel connection mode and a series connection mode by changing each of the first semiconductor switch to the fourth semiconductor switch between a conductive state and an interrupted state, the parallel connection mode is a mode in which the first direct-current power supply and the second direct-current power supply are connected to the load circuit in parallel with each other, and the series connection mode is a mode in which the first direct-current power supply and the second direct-current power supply are connected to the load circuit in series with each other.

The electronic control unit is configured to step up a terminal voltage of the first direct-current power supply or the second direct-current power supply and then apply the stepped-up voltage between the positive electrode connection point and the negative electrode connection point, or step down a voltage between the positive electrode connection point and the negative electrode connection point and then apply the stepped-down voltage to the first direct-current power supply or the second direct-current power supply.

The electronic control unit includes an arithmetic processing unit and a logic circuit unit, the arithmetic processing unit is configured to generate a control signal for changing each of the first semiconductor switch to the fourth semiconductor switch between the conductive state and the interrupted state, the logic circuit unit is configured to transmit the control signals to the first semiconductor switch to the fourth semiconductor switch and receive the detection signals from the first semiconductor switch to the fourth semiconductor switch.

The logic circuit unit is configured to, when the logic circuit unit has received the detection signal from the first semiconductor switch or the third semiconductor switch, output a first overcurrent signal to the arithmetic processing unit. The logic circuit unit is configured to, when the logic circuit unit has received the detection signal from the second semiconductor switch or the fourth semiconductor switch, output a second overcurrent signal to the arithmetic processing unit. In other words, the arithmetic processing unit can receive two overcurrent signals from the logic circuit unit.

The logic circuit unit is configured to, when the logic circuit unit is receiving the detection signal from at least one of the first semiconductor switch to the fourth semiconductor switch, execute interruption process for keeping each of the first semiconductor switch to the fourth semiconductor switch in the interrupted state irrespective of the control signal.

For example, when there is a short-circuit failure in the second semiconductor switch and the third semiconductor switch is controlled to the conductive state in response to the control signal, a closed circuit including the first direct-current power supply is established (see the wide line B1 in FIG. 8). When current flowing through the closed circuit becomes excessive, the first overcurrent signal and the second overcurrent signal are input to the arithmetic processing unit.

Alternatively, when there occurs a short-circuit failure in the fourth semiconductor switch and the first semiconductor switch is controlled to the conductive state in response to the control signal, a closed circuit including the first direct-current power supply is established (see the wide line B2 in FIG. 9). When current flowing through the closed circuit becomes excessive, the first overcurrent signal and the second overcurrent signal are input to the arithmetic processing unit.

Alternatively, when there occurs a short-circuit failure in the third semiconductor switch and the fourth semiconductor switch is controlled to the conductive state in response to the control signal, a closed circuit including the first direct-current power supply is established (see the wide line B3 in FIG. 10). When current flowing through the closed circuit becomes excessive, the first overcurrent signal and the second overcurrent signal are input to the arithmetic processing unit.

Alternatively, when there occurs a short-circuit failure in the second semiconductor switch and the first semiconductor switch is controlled to the conductive state in response to the control signal, a closed circuit including the first direct-current power supply is established (see the wide line B4 in FIG. 11). When current flowing through the closed circuit becomes excessive, the first overcurrent signal and the second overcurrent signal are input to the arithmetic processing unit.

Even when there occurs a failure in one of the overcurrent detection units of the two semiconductor switches included in the closed circuit, which can output the detection signal in the event of occurrence of an overcurrent, one of the first overcurrent signal and the second overcurrent signal is input to the arithmetic processing unit on the basis of the detection signal that is output from the other one of the overcurrent detection units.

On the other hand, the logic circuit unit is configured to, when the logic circuit unit is outputting the first overcurrent signal or the second overcurrent signal to the arithmetic processing unit, that is, when there is an overcurrent in at least one of the first semiconductor switch to the fourth semiconductor switch, execute the interruption process. That is, the logic circuit unit is configured to keep the first semiconductor switch to the fourth semiconductor switch in the interrupted state.

Therefore, with the system according to the invention, it is possible to detect occurrence of an overcurrent in various situations while suppressing the number of input ports of the arithmetic processing unit, which are used to detect occurrence of an overcurrent, from four to two. With the system according to the invention, in the event of occurrence of an overcurrent, the first semiconductor switch to the fourth semiconductor switch are controlled to the interrupted state, thus making it possible to eliminate the overcurrent.

For example, the system according to the invention may be configured to, in the event of occurrence of an overcurrent resulting from occurrence of a short-circuit failure, execute degenerate operation for supplying the load circuit with only direct-current power that is output from only one of the first direct-current power supply and the second direct-current power supply.

In the above-described aspect of the system according to the invention, the arithmetic processing unit may be configured to, when the arithmetic processing unit has received the first overcurrent signal or the second overcurrent signal continuously for a predetermined period, output an interruption process cancellation signal to the logic circuit unit, and the logic circuit unit may be configured to, when the logic circuit unit is receiving the interruption process cancellation signal from the arithmetic processing unit, stop the interruption process.

The overcurrent detection unit may fail at the time when there occurs an overcurrent, with the result that the overcurrent detection unit may continue to output the detection signal. In this case, all the first semiconductor switch to the fourth semiconductor switch continue to be kept in the interrupted state, so there is a concern that it is not possible to control a specific one of the semiconductor switches to the conductive state and, as a result, execution of the above-described degenerate operation is hindered.

However, according to this aspect, when the detection signal is continuously output, it is possible to control the first semiconductor switch to the fourth semiconductor switch by the arithmetic processing unit due to the interruption process cancellation signal. Therefore, according to this aspect, even when the detection signal is continuously output, it is possible to reliably execute degenerate operation.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view of a vehicle on which a power supply system (the system) according to an embodiment of the invention is mounted;

FIG. 2 is a table that shows a connection mode of the system, which is determined on the basis of the relation between terminal voltages of two storage batteries and a high-voltage-side voltage, and whether step-up operation is performed;

FIG. 3 is a table that shows the state of each of semiconductor switches for each of the connection modes of the system;

FIG. 4 is a schematic view that shows an equivalent circuit in the case where the system executes a parallel connection mode;

FIG. 5 is a schematic view that shows an equivalent circuit in the case where the system executes another parallel connection mode;

FIG. 6 is a schematic view that shows an equivalent circuit in the case where the system executes a series connection mode;

FIG. 7 is a logic circuit diagram that roughly shows a chip set included in a control unit of the system;

FIG. 8 is a partial circuit diagram that shows a current path at the time when an overcurrent has occurred in the system;

FIG. 9 is a partial circuit diagram that shows a current path at the time when another overcurrent has occurred in the system;

FIG. 10 is a partial circuit diagram that shows a current path at the time when another overcurrent has occurred in the system;

FIG. 11 is a partial circuit diagram that shows a current path at the time when another overcurrent has occurred in the system;

FIG. 12 is a flowchart that shows an overcurrent detection process routine that is executed by the control unit of the system; and

FIG. 13 is a flowchart that shows a degenerate operation start process routine that is executed by the control unit of the system.

### DETAILED DESCRIPTION OF EMBODIMENTS

### Configuration

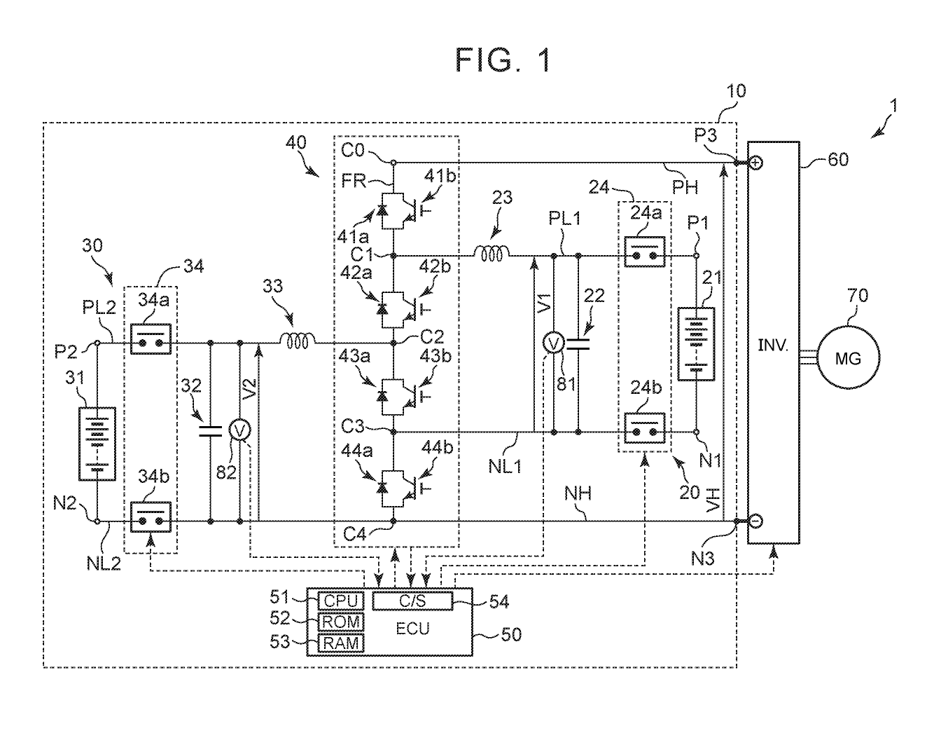

Hereinafter, a power supply system 10 (hereinafter, also referred to as the system) according to an embodiment of the invention will be described with reference to the accompanying drawings. The system is mounted on a vehicle 1 of which the schematic configuration is shown in FIG. 1. The vehicle 1 is an electric vehicle.

The system includes a first power supply unit 20, a second power supply unit 30, a switch unit 40 and an electronic control unit (ECU) 50. The vehicle 1 further includes an inverter 60 and an electric motor 70.

The first power supply unit 20 includes a first storage battery 21, a first capacitor 22, a first reactor 23 and a first system main relay 24 (SMR1).

The first storage battery 21 is a chargeable and dischargeable lithium ion battery. The positive electrode (P1) and negative electrode (N1) of the first storage battery 21 are respectively connected to one ends of a pair of power supply lines (PL1, NL1). The other ends of the pair of power supply lines (PL1, NL1) are connected to the switch unit 40.

The first capacitor 22 is connected between the pair of power supply lines (PL1, NL1). That is, the first capacitor 22 is connected in parallel with the first storage battery 21. The first capacitor 22 smoothes a terminal voltage V1 between the positive electrode and negative electrode of the first storage battery 21. The first reactor 23 is interposed in the power supply line (PL1) at a portion between the first capacitor 22 and the switch unit 40.

The first system main relay 24 includes a first positive electrode switch 24a and a first negative electrode switch 24b. The first positive electrode switch 24a is interposed in the power supply line (PL1) at a portion between the first storage battery 21 and the first capacitor 22. The first negative electrode switch 24b is interposed in the power supply line (NL1) at a portion between the first storage battery 21 and the first capacitor 22. The first system main relay 24 is able to cut off current flowing through the first storage battery 21.

The second power supply unit 30 includes a second storage battery 31, a second capacitor 32, a second reactor 33 and a second system main relay 34 (SMR2).

The second storage battery 31 is a lithium ion battery that is able to be charged or discharged. The positive electrode (P2) and negative electrode (N2) of the second storage battery 31 are respectively connected to one ends of a pair of power supply lines (PL2, NL2). The other ends of the pair of power supply lines (PL2, NL2) are connected to the switch unit 40.

The second capacitor 32 is connected between the pair of power supply lines (PL2, NL2). That is, the second capacitor 32 is connected in parallel with the second storage battery 31. The second capacitor 32 smoothes a terminal voltage V2 between the positive electrode and negative electrode of the second storage battery 31. The second reactor 33 is interposed in the power supply line (PL2) at a portion between the second capacitor 32 and the switch unit 40.

The second system main relay 34 includes a second positive electrode switch 34a and a second negative electrode switch 34b. The second positive electrode switch 34a is interposed in the power supply line (PL2) at a portion between the second storage battery 31 and the second capacitor 32. The second negative electrode switch 34b is interposed in the power supply line (NL2) at a portion between the second storage battery 31 and the second capacitor 32. The second system main relay 34 is able to cut off current flowing through the second storage battery 31.

The switch unit 40 includes a first diode 41a to a fourth diode 44a, a first IGBT 41b (SW1) to a fourth IGBT 44b (SW4) and a power supply line (FR).

The power supply line (FR) includes a connection point C0 to a connection point C4. The connection point C0 to the connection point C4 are arranged in order of the connection point C0, the connection point C1, the connection point C2, the connection point C3 and the connection point C4. The connection point C0 at one end of the power supply line (FR) is connected to one end of a power supply line (PH). The connection point C4 at the other end of the power supply line (FR) is connected to one end of a power supply line (NH).

The first diode 41a is interposed in the power supply line (FR) at a portion between the connection point C0 and the connection point C1. The cathode of the first diode 41a is on the connection point C0 side, and the anode of the first diode 41a is on the connection point C1 side. The first IGBT 41b is connected in antiparallel with the first diode 41a.

The second diode 42a is interposed in the power supply line (FR) at a portion between the connection point C1 and the connection point C2. The cathode of the second diode 42a is on the connection point C1 side, and the anode of the second diode 42a is on the connection point C2 side. The second IGBT 42b is connected in antiparallel with the second diode 42a.

The third diode 43a is interposed in the power supply line (FR) at a portion between the connection point C2 and the connection point C3. The cathode of the third diode 43a is on the connection point C2 side, and the anode of the third diode 43a is on the connection point C3 side. The third IGBT 43b is connected in antiparallel with the third diode 43a.

The fourth diode 44a is interposed in the power supply line (FR) at a portion between the connection point C3 and the connection point C4. The cathode of the fourth diode 44a is on the connection point C3 side, and the anode of the fourth diode 44a is on the connection point C4 side. The fourth IGBT 44b is connected in antiparallel with the fourth diode 44a.

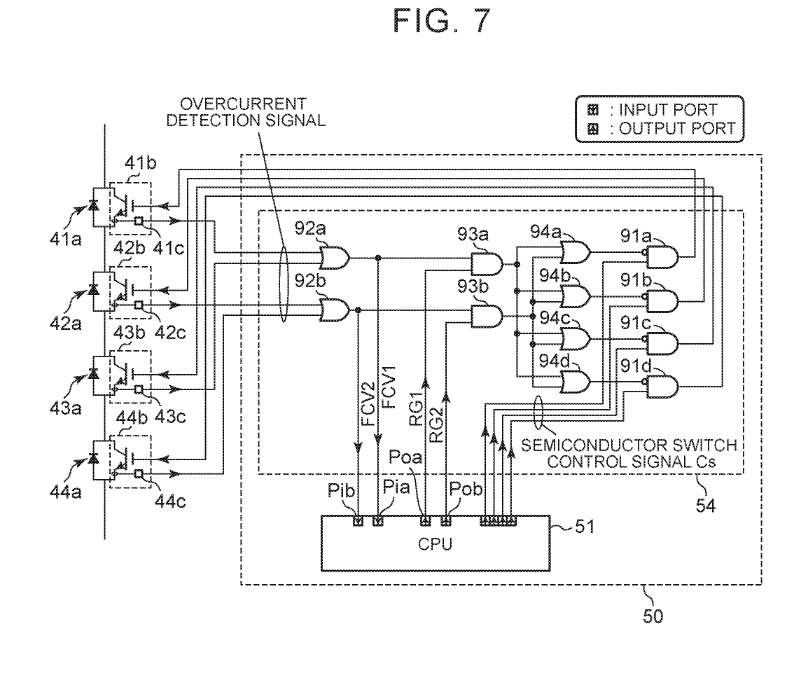

The first IGBT 41b to the fourth IGBT 44b respectively include a first overcurrent detection unit 41c to a fourth overcurrent detection unit 44c as shown in FIG. 7 (described later). Each of the first overcurrent detection unit 41c to the fourth overcurrent detection unit 44c outputs a detection signal to the ECU 50 (described later) when current flowing through a corresponding one of the semiconductor switches (any one of the first IGBT 41b to the fourth IGBT 44b) exceeds a predetermined threshold. The configuration of each of the first overcurrent detection unit 41c to the fourth overcurrent detection unit 44c is, for example, described in Japanese Patent Application Publication No. 2010-244367 (JP 2010-244367 A) and Japanese Patent Application Publication No. 2014-187543 (JP 2014-187543 A).

The power supply line (PL1) of the first power supply unit 20 is connected to the connection point C1. The power supply line (PL2) of the second power supply unit 30 is connected to the connection point C2. The power supply line (NL1) of the first power supply unit 20 is connected to the connection point C3. The power supply line (NL2) of the second power supply unit 30 is connected to the connection point C4.

The other end of the power supply line (PH) is connected to a positive electrode connection point (P3). The other end of the power supply line (NH) is connected to a negative electrode connection point (N3). Each of the positive electrode connection point (P3) and the negative electrode connection point (N3) is connected to the inverter 60 (described later).

The switch unit 40 steps up direct-current voltage that is output from the first storage battery 21 and/or the second storage battery 31 and applies the stepped-up voltage to the inverter 60 by controlling the conductive states of the first IGBT 41b to the fourth IGBT 44b (described later).

The ECU 50 includes a CPU 51, a ROM 52, a RAM 53 and a chip set 54. The ECU 50 is a microcomputer. The CPU 51 executes various arithmetic processing for controlling the power supply system 10. The ROM 52 stores programs that are executed by the CPU 51, maps (lookup tables), and the like. The RAM 53 temporarily stores data that are referenced by the CPU 51. The chip set 54 is an integrated circuit including logic circuits, and controls communication with various actuators, sensors, and the like, connected to the ECU 50.

The ECU 50 controls the inverter 60 and the state (conductive state or interrupted state) of each of the first IGBT 41b to the fourth IGBT 44b, the first system main relay 24 and the second system main relay 34. The ECU 50 is connected to a first voltage sensor 81 and a second voltage sensor 82 (described later).

The inverter 60 includes a plurality of semiconductor switches (not shown) (IGBTs in the present embodiment). The inverter 60 converts direct-current power (high-voltage-side voltage VH), output from the switch unit 40 between the positive electrode connection point (P3) and the negative electrode connection point (N3), to three-phase, that is, U-phase, V-phase and W-phase alternating-current power, and outputs the three-phase alternating-current power to the electric motor 70. The inverter 60 is also referred to as load circuit for the sake of convenience.

When the electric motor 70 operates as a generator, the inverter 60 converts alternating-current power, output from the electric motor 70, to direct-current power, and outputs the direct-current power between the positive electrode connection point (P3) and the negative electrode connection point (N3), that is, to the switch unit 40. In this case, the switch unit 40 steps down the direct-current voltage and applies the stepped-down voltage to the first storage battery 21 and/or the second storage battery 31 by controlling the conductive state of each of the first IGBT 41b to the fourth IGBT 44b (described later). As a result, the first storage battery 21 and/or the second storage battery 31 is charged.

The electric motor 70 includes a stator and a rotor. The stator includes three-phase coils (coils) that generate revolving magnetic fields. The rotor includes permanent magnets that generate torque by using magnetic force that attract or repulse the revolving magnetic fields. The electric motor 70 is able to not only operate as an electric motor but also operate as a generator. When the electric motor 70 operates as an electric motor, the electric motor 70 generates driving force of the vehicle 1 (torque for propelling the vehicle).

The first voltage sensor 81 generates a signal indicating the terminal voltage V1 of the first storage battery 21. The second voltage sensor 82 generates a signal indicating the terminal voltage V2 of the second storage battery 31.

### Operation

When there is an overcurrent in at least one of the first IGBT 41b to the fourth IGBT 44b, the ECU 50 eliminates the overcurrent by executing interruption process for controlling each of the first IGBT 41b to the fourth IGBT 44b to the interrupted state. On the other hand, when the above-described detection signal continues to be output due to a failure of any one of the first overcurrent detection unit 41c to the fourth overcurrent detection unit 44c, the CPU 51 (hereinafter, also simply referred to as CPU) of the ECU 50 stops the above-described interruption process.

Initially, control over the state (conductive state or interrupted state) of each of the first IGBT 41b to the fourth IGBT 44b, which is executed by the CPU, will be described. During operation of the vehicle 1, the CPU keeps the first system main relay 24 and the second system main relay 34 in the conductive state.

The CPU executes a parallel connection mode in which electric power is supplied to the inverter 60 in a state where the first storage battery 21 and the second storage battery 31 are connected in parallel with each other by keeping any one of the second IGBT 42b and the fourth IGBT 44b in the conductive state. When a request to execute the parallel connection mode has been issued, each of the terminal voltage V1 of the first storage battery 21 and the terminal voltage V2 of the second storage battery 31 becomes the high-voltage-side voltage VH (that is, V1=V2=VH). In addition, when the voltage V1 and the voltage V2 are stepped up through step-up operation (described later), each of the stepped-up voltage V1 and the stepped-up voltage V2 is equal to the high-voltage-side voltage VH.

Alternatively, the CPU executes a series connection mode in which electric power is supplied to the inverter 60 in a state where the first storage battery 21 and the second storage battery 31 are connected in series with each other by keeping the third IGBT 43b in the conductive state. When a request to execute the series connection mode has been issued, the sum of the terminal voltage V1 of the first storage battery 21 and the terminal voltage V2 of the second storage battery 31 becomes the high-voltage-side voltage VH (that is, V1+V2=VH). In addition, when the voltage V1 and the voltage V2 are stepped up through step-up operation (described later), the sum of the stepped-up voltage V1 and the stepped-up voltage V2 is equal to the high-voltage-side voltage VH.

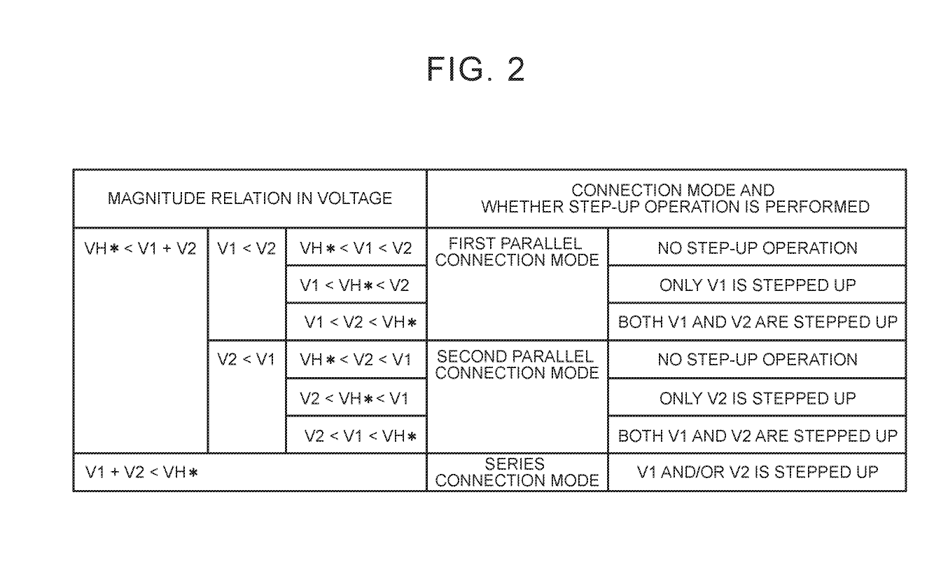

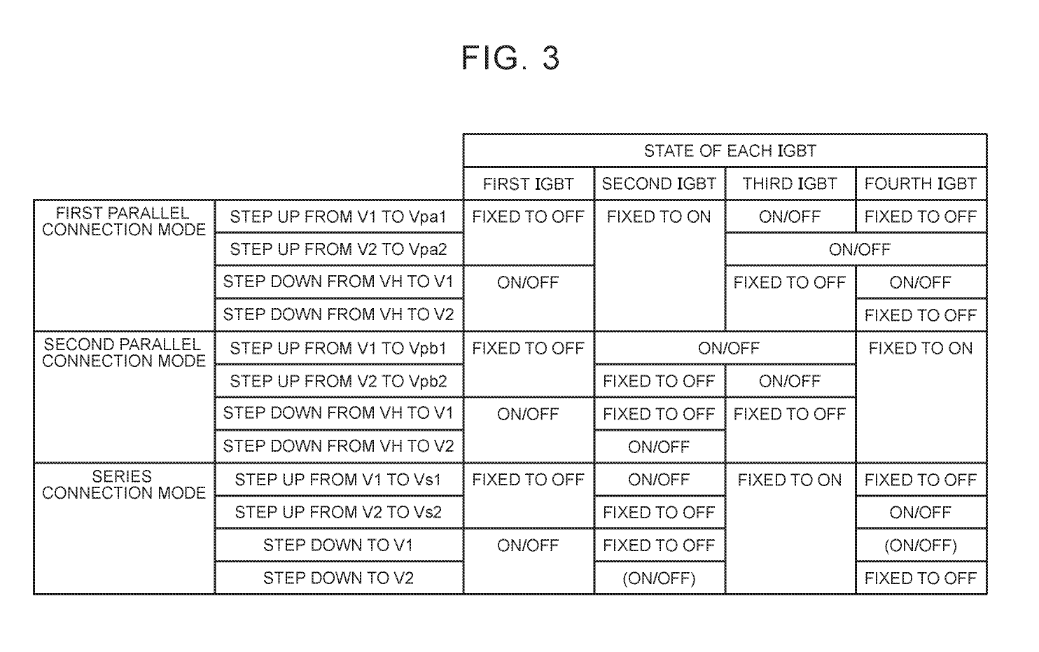

The CPU selectively executes any one of the parallel connection mode and the series connection mode. FIG. 2 shows the connection mode, which is determined on the basis of the magnitude relation among the voltage V1, the voltage V2 and a target high-voltage-side voltage VH*, and whether step-up operation is performed. FIG. 3 shows the state (conductive state or interrupted state) of each of the first IGBT 41b to the fourth IGBT 44b for each of the connection modes. The details of the parallel connection mode and the series connection mode will be described below.

### 1 Parallel Connection Mode

When a request to execute the parallel connection mode has been issued, the CPU changes the operation state of the system in response to the magnitude relation between the terminal voltage V1 of the first storage battery 21 and the terminal voltage V2 of the second storage battery 31.

### 1-1 Voltage V1<Voltage V2

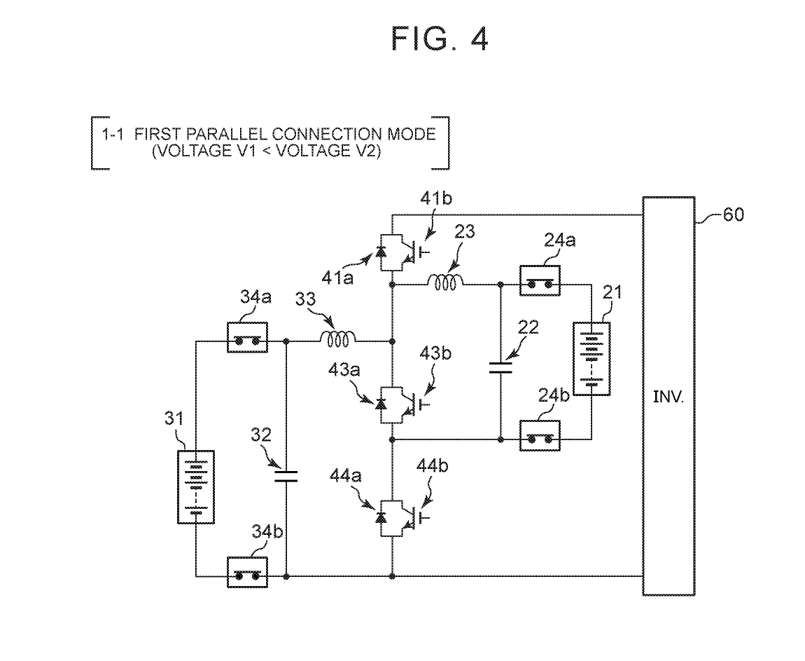

When a request to execute the parallel connection mode has been issued, and when the voltage V1 is lower than the voltage V2, the CPU keeps the second IGBT 42b in the conductive state. As a result, the first storage battery 21 and the second storage battery 31 are connected to the inverter 60 in parallel with each other. FIG. 4 shows an equivalent circuit of the system in this case. The parallel connection mode that is implemented by keeping the second IGBT 42b in the conductive state is also referred to as first parallel connection mode.

(1a) In this state, when the third IGBT 43b is in the conductive state and the fourth IGBT 44b is in the interrupted state, current flows from the positive electrode of the first storage battery 21 to the negative electrode of the first storage battery 21 via the first reactor 23, so energy is stored in the first reactor 23. After that, when the third IGBT 43b changes to the interrupted state, energy stored in the first reactor 23 is released, and is supplied to the inverter 60. After that, the voltage V1 that is generated by the first storage battery 21 is stepped up to a stepped-up voltage Vpa1, and the stepped-up voltage Vpa1 is applied to the inverter 60. That is, in this case, the first power supply unit 20 and the switch unit 40 operate as a step-up chopper circuit in which the third IGBT 43b functions as a lower arm element.

Where a conduction ratio of the lower arm element (that is, the third IGBT 43b) is a duty ratio Dpa1, the stepped-up voltage Vpa1 is expressed by the following mathematical expression (1).

Vpa1={1/(1−Dpa1)}·V1 (1)

The duty ratio (conduction ratio) is the ratio of a time during which a semiconductor switch is in a conductive state to a time (that is, switching interval) from the time at which the semiconductor switch switches from the interrupted state to the conductive state, after that, changes to the interrupted state, and then to the time at which the semiconductor switch changes to the conductive state again.

(1b) On the other hand, when both the third IGBT 43b and the fourth IGBT 44b are in the conductive state, current flows from the positive electrode of the second storage battery 31 to the negative electrode of the second storage battery 31 via the second reactor 33, so energy is stored in not only the first reactor 23 but also the second reactor 33. After that, when at least one of the third IGBT 43b and the fourth IGBT 44b changes to the interrupted state, energy stored in the second reactor 33 is released, and is supplied to the inverter 60. As a result, the voltage V2 that is generated by the second storage battery 31 is stepped up to a stepped-up voltage Vpa2, and the stepped-up voltage Vpa2 is applied to the inverter 60. That is, in this case, the second power supply unit 30 and the switch unit 40 operate as a step-up chopper circuit in which the third IGBT 43b and the fourth IGBT 44b function as lower arm elements.

Where the conduction ratio of the lower arm elements (that is, the third IGBT 43b and the fourth IGBT 44b) is a duty ratio Dpa2, the stepped-up voltage Vpa2 is expressed by the following mathematical expression (2).

Vpa2={1/(1−Dpa2)}·V2 (2)

As is understood from the above-described mathematical expression (1) and mathematical expression (2), a step-up rate Rv1 (Step-up rate Rv1=Stepped-up voltage Vpa1/Terminal voltage V1) of the first storage battery 21 increases as the duty ratio Dpa1 increases. In addition, a step-up rate Rv2 (Step-up rate Rv2=Stepped-up voltage Vpa2/Terminal voltage V2) of the second storage battery 31 increases as the duty ratio Dpa2 increases.

A time during which both the third IGBT 43b and the fourth IGBT 44b are in the conductive state is shorter than or equal to a time during which only the third IGBT 43b is in the conductive state, so the duty ratio Dpa2 is smaller than or equal to the duty ratio Dpa1 (that is, Dpa1 Dpa2). Therefore, Step-up rate Rv1≧Step-up rate Rv2.

On the other hand, the stepped-up voltage Vpa1 and the stepped-up voltage Vpa2 each are equal to the high-voltage-side voltage VH (that is, Vpa1=Vpa2=VH). Because Step-up rate Rv1≧Step-up rate Rv2, the relationship Voltage V1 Voltage V2 is required in order to step up both the voltage V1 and the voltage V2 to the high-voltage-side voltage VH. In other words, when the voltage V1 is lower than the voltage V2 (that is, V1<V2) while a request to execute the parallel connection mode has been issued, the first parallel connection mode is selected. On the other hand, when the voltage V1 is higher than the voltage V2 (that is, V1>V2) while a request to execute the parallel connection mode has been issued, the CPU selects the second parallel connection mode (described later).

(2a) When the first storage battery 21 and/or the second storage battery 31 is charged by using the direct-current voltage that is generated by the inverter 60, the first IGBT 41b is controlled. More specifically, when the first IGBT 41b is in the conductive state and the fourth IGBT 44b is in the interrupted state, current flows from the positive electrode connection point (P3) to the negative electrode connection point (N3) via the second reactor 33 by using the direct-current voltage that is generated by the inverter 60 (that is, the high-voltage-side voltage VH), so energy is stored in the second reactor 33. After that, when the first IGBT 41b changes to the interrupted state, energy stored in the second reactor 33 is released. That is, in this case, voltage that is generated by the inverter 60 is stepped down, and the stepped-down voltage is applied to the second storage battery 31. That is, the second power supply unit 30 and the switch unit 40 operate as a step-down chopper circuit in which the first IGBT 41b functions as an upper arm element.

(2b) When both the first IGBT 41b and the fourth IGBT 44b are in the conductive state, current flows from the positive electrode connection point (P3) to the negative electrode connection point (N3) via the first reactor 23 by using the direct-current voltage that is generated by the inverter 60, so energy is stored in not only the second reactor 33 but also the first reactor 23. After that, when at least one of the first IGBT 41b and the fourth IGBT 44b changes to the interrupted state, energy stored in the first reactor 23 is released. That is, in this case, voltage that is generated by the inverter 60 is stepped down, and the stepped-down voltage is applied to the first storage battery 21. In other words, the first power supply unit 20 and the switch unit 40 operate as a step-down chopper circuit in which the first IGBT 41b and the fourth IGBT 44b function as upper arm elements.

### 1-2 Voltage V1>Voltage V2

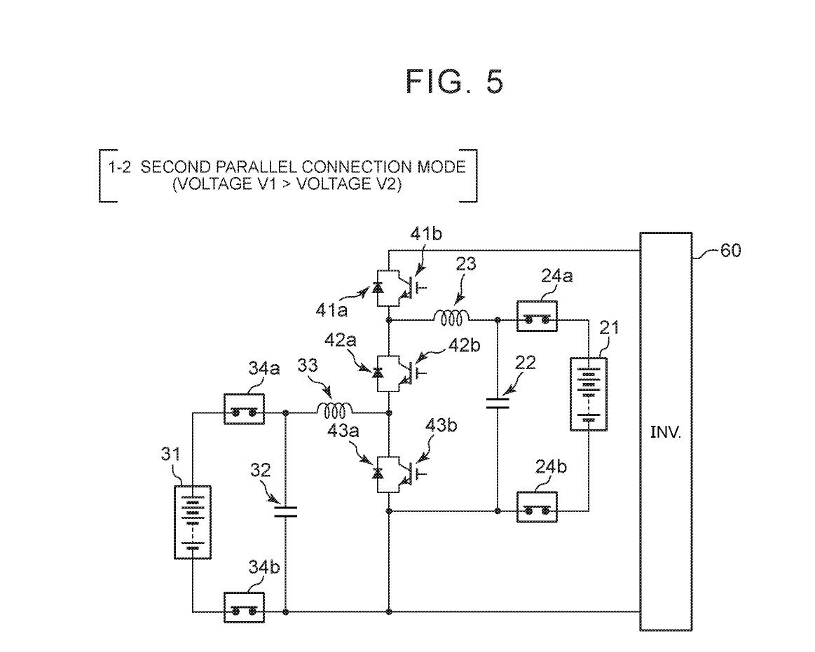

As described above, when a request to execute the parallel connection mode has been issued, and when the voltage V1 is higher than the voltage V2, the CPU keeps the fourth IGBT 44b in the conductive state. As a result, the first storage battery 21 and the second storage battery 31 are connected to the inverter 60 in parallel with each other. FIG. 5 shows an equivalent circuit of the system in this case. The parallel connection mode that is implemented by keeping the fourth IGBT 44b in the conductive state is also referred to as second parallel connection mode.

(1a) In this state, when the third IGBT 43b is in the conductive state and the second IGBT 42b is in the interrupted state, current flows from the positive electrode of the second storage battery 31 to the negative electrode of the second storage battery 31 via the second reactor 33, so energy is stored in the second reactor 33. After that, when the third IGBT 43b changes to the interrupted state, energy stored in the second reactor 33 is released, and is supplied to the inverter 60. As a result, the voltage V2 that is generated by the second storage battery 31 is stepped up to a stepped-up voltage Vpb2, and the stepped-up voltage Vpb2 is applied to the inverter 60. That is, in this case, the second power supply unit 30 and the switch unit 40 operate as a step-up chopper circuit in which the third IGBT 43b functions as a lower arm element.

Where a conduction rate of the lower arm element (that is, the third IGBT 43b) is a duty ratio Dpb2, the stepped-up voltage Vpb2 is expressed by the following mathematical expression (3).

Vpb2={1/(1−Dpb2)}·V2 (3)

(1b) On the other hand, when both the second IGBT 42b and the third IGBT 43b are in the conductive state, current flows from the positive electrode of the first storage battery 21 to the negative electrode of the first storage battery 21 via the first reactor 23, so energy is stored in not only the second reactor 33 but also the first reactor 23. After that, when at least one of the second IGBT 42b and the third IGBT 43b changes to the interrupted state, energy stored in the first reactor 23 is released, and is supplied to the inverter 60. As a result, the voltage V1 that is generated by the first storage battery 21 is stepped up to a stepped-up voltage Vpb1, and the stepped-up voltage Vpb1 is applied to the inverter 60. That is, in this case, the first power supply unit 20 and the switch unit 40 operate as a step-up chopper circuit in which the second IGBT 42b and the third IGBT 43b function as lower arm elements.

Where a conduction rate of the lower arm elements (that is, the second IGBT 42b and the third IGBT 43b) is a duty ratio Dpb1, the stepped-up voltage Vpb1 is expressed by the following mathematical expression (4).

Vpb1={1/(1−Dpb1)}·V1 (4)

(2a) When the first storage battery 21 and/or the second storage battery 31 is charged by using the direct-current voltage that is generated by the inverter 60, the first IGBT 41b is controlled. More specifically, when the first IGBT 41b is in the conductive state and the second IGBT 42b is in the interrupted state, current flows from the positive electrode connection point (P3) to the negative electrode connection point (N3) via the first reactor 23 by using the direct-current voltage that is generated by the inverter 60 (the high-voltage-side voltage VH), so energy is stored in the first reactor 23. After that, when the first IGBT 41b changes to the interrupted state, energy stored in the first reactor 23 is released. That is, in this case, voltage that is generated by the inverter 60 is stepped down, and the stepped-down voltage is applied to the first storage battery 21. That is, the first power supply unit 20 and the switch unit 40 operate as a step-down chopper circuit in which the first IGBT 41b functions as an upper arm element.

(2b) When both the first IGBT 41b and the second IGBT 42b are in the conductive state, current flows from the positive electrode connection point (P3) to the negative electrode connection point (N3) via the second reactor 33 by using the direct-current voltage that is generated by the inverter 60, so energy is stored in not only the first reactor 23 but also the second reactor 33. After that, when at least one of the first IGBT 41b and the second IGBT 42b changes to the interrupted state, energy stored in the second reactor 33 is released. That is, in this case, voltage that is generated by the inverter 60 is stepped down, and the stepped-down voltage is applied to the second storage battery 31. In other words, the second power supply unit 30 and the switch unit 40 operate as a step-down chopper circuit in which the first IGBT 41b and the second IGBT 42b function as upper arm elements.

### 2 Series Connection Mode

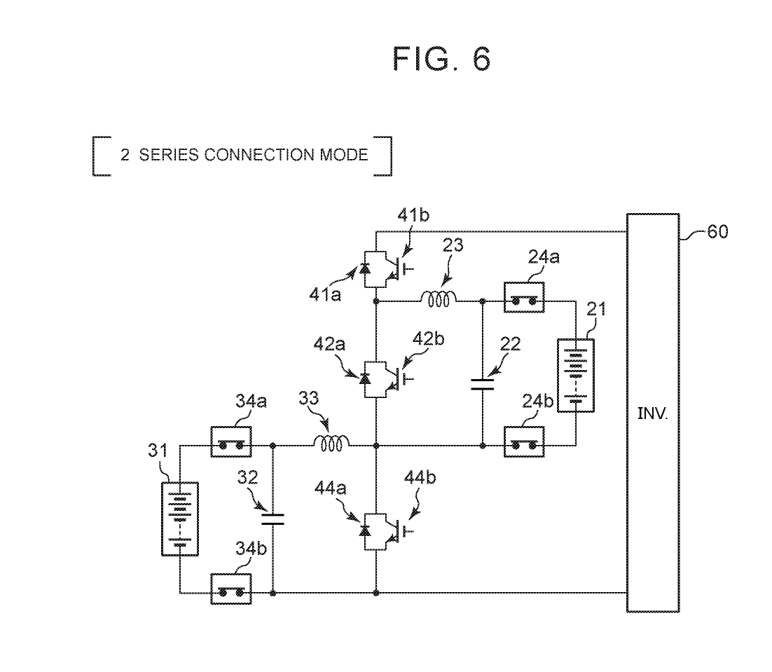

When a request to execute the series connection mode has been issued, the CPU keeps the third IGBT 43b in the conductive state. As a result, the first storage battery 21 and the second storage battery 31 are connected to the inverter 60 in series with each other. FIG. 6 shows an equivalent circuit of the system in this case.

(1a) In this state, when the second IGBT 42b is in the conductive state, current flows from the positive electrode of the first storage battery 21 to the negative electrode of the first storage battery 21 via the first reactor 23, so energy is stored in the first reactor 23. After that, when the second IGBT 42b changes to the interrupted state, energy stored in the first reactor 23 is released, and is supplied to the inverter 60. As a result, the voltage V1 that is generated by the first storage battery 21 is stepped up to a stepped-up voltage Vs1. That is, in this case, the first power supply unit 20 and the switch unit 40 operate as a step-up chopper circuit in which the second IGBT 42b functions as a lower arm element.

Where a conduction rate of the lower arm element (that is, the second IGBT 42b) is a duty ratio Ds1, the stepped-up voltage Vs1 is expressed by the following mathematical expression (5).

Vs1={1/(1−Ds1)}·V1 (5)

(1b) On the other hand, when the fourth IGBT 44b is in the conductive state, current flows from the positive electrode of the second storage battery 31 to the negative electrode of the second storage battery 31 via the second reactor 33, so energy is stored in the second reactor 33. After that, when the fourth IGBT 44b changes to the interrupted state, energy stored in the second reactor 33 is released, and is supplied to the inverter 60. As a result, the voltage V2 that is generated by the second storage battery 31 is stepped up to a stepped-up voltage Vs2. That is, in this case, the second power supply unit 30 and the switch unit 40 operate as a step-up chopper circuit in which the fourth IGBT 44b functions as a lower arm element.

Where a conduction rate of the lower arm element (that is, the fourth IGBT 44b) is a duty ratio Ds2, the stepped-up voltage Vs2 is expressed by the following mathematical expression (6).

Vs2={1/(1−Ds2)}·V2 (6)

When the series connection mode is executed, the high-voltage-side voltage VH is equal to the sum of the stepped-up voltage Vs1 and the stepped-up voltage Vs2 (that is, VH=Vs1+Vs2). That is, the voltage equal to the sum of the stepped-up voltage Vs1 and the stepped-up voltage Vs2 is applied to the inverter 60.

(2) When the first storage battery 21 and/or the second storage battery 31 is charged by using the direct-current voltage that is generated by the inverter 60, the first IGBT 41b is controlled. More specifically, when the first IGBT 41b is in the conductive state, current flows from the positive electrode connection point (P3) to the negative electrode connection point (N3) via the first reactor 23 by using the direct-current voltage that is generated by the inverter 60 (the high-voltage-side voltage VH), so energy is stored in the first reactor 23. Similarly, when the first IGBT 41b is in the conductive state, current flows from the positive electrode connection point (P3) to the negative electrode connection point (N3) via the second reactor 33, so energy is stored in the second reactor 33.

Alternatively, when both the first IGBT 41b and the fourth IGBT 44b are in the conductive state, energy is stored in only the first reactor 23. On the other hand, when both the first IGBT 41b and the second IGBT 42b are in the conductive state, energy is stored in only the second reactor 33.

After that, when the first IGBT 41b changes to the interrupted state, energy stored in each of the first reactor 23 and the second reactor 33 is released. In this case, voltage that is generated by the inverter 60 is stepped down, and the stepped-down voltage is applied to each of the first storage battery 21 and the second storage battery 31. That is, in this case, the first power supply unit 20 and/or the second power supply unit 30 and the switch unit 40 operate as a step-down chopper circuit in which the first IGBT 41b functions as an upper arm element.

### 3 Selection of Parallel Connection Mode or Series Connection Mode

The CPU selects any one of the parallel connection mode and the series connection mode as a connection mode in response to a target high-voltage-side voltage VH* that is a target value of the high-voltage-side voltage VH. The CPU sets the target high-voltage-side voltage VH* to a higher value as a required output of the electric motor 70 increases.

When the target high-voltage-side voltage VH* is low, the CPU selects the parallel connection mode (specifically, any one of the first parallel connection mode and the second parallel connection mode). When a request to execute the parallel connection mode has been issued, and when the voltage V1 and/or the voltage V2 is lower than the target high-voltage-side voltage VH* (that is, the relationship V1<VH* and/or the relationship V2<VH* holds), the CPU executes step-up process in the above-described parallel connection mode.

The CPU sets a set of the duty ratio Dpa1 and the duty ratio Dpa2 or a set of the duty ratio Dpb1 and the duty ratio Dpb2 to higher values as the target high-voltage-side voltage VH* increases. As the duty ratio increases, energy that is stored in the first reactor 23 and/or the second reactor 33 increases. Therefore, when the duty ratio is high, energy to be stored may exceed the capacity (a substantially maximum value of energy that is allowed to be stored) of the first reactor 23 and/or the second reactor 33.

On the other hand, when the duty ratio is the same, the duration of the conductive state of the semiconductor switch (in the present embodiment, the above-described lower arm element) shortens as the above-described switching interval shortens, so the maximum value of the amount of energy that is stored in the reactor reduces. Therefore, when the duty ratio is high, the maximum value of the amount of energy that is stored in the first reactor 23 and/or the second reactor 33 is reduced, so it is necessary to shorten the switching interval of the semiconductor switch.

However, when the duty ratio is the same, the number of times per unit time the semiconductor switch changes between the conductive state and the interrupted state as the switching interval shortens, so a switching loss increases as compared to when the switching interval is long. In other words, as the duty ratio increases, the switching loss can increase. Therefore, when the target high-voltage-side voltage VH* is higher than the sum of the voltage V1 and the voltage V2 (that is, the relationship Voltage V1+Voltage V2<Target high-voltage-side voltage VH* holds), the CPU selects the series connection mode.

When the target high-voltage-side voltage VH* is the same, the duty ratio in the case where the step-up process in the series connection mode is executed is smaller than the duty ratio in the case where the step-up process in the parallel connection mode is executed. As a result, even when the target high-voltage-side voltage VH* increases, it is possible to avoid an increase in switching loss.

### Outline of Chip Set

FIG. 7 shows the outline of logic circuits that are used in control over the first IGBT 41b to the fourth IGBT 44b and that are included in the chip set 54. Signals that are exchanged between the chip set 54 and a set of the CPU and the first IGBT 41b to the fourth IGBT 44b and signals that are exchanged among the logic circuits included in the chip set 54 each are configured as a high or low state of voltage.

For example, when a signal that is output from the chip set 54 to any one of the first IGBT 41b to the fourth IGBT 44b is a high voltage, the corresponding semiconductor switch (IGBT) is controlled to the conductive state. On the other hand, when a signal that is output from the chip set 54 to any one of the first IGBT 41b to the fourth IGBT 44b is a low voltage (for example, 0 V), the corresponding semiconductor switch (IGBT) is controlled to the interrupted state. In the specification, for the sake of convenience, a state where the voltage is high is described that the value is “1”, and a state where the voltage is low is described that the value is “0”.

The CPU outputs control signals Cs to the first IGBT 41b to the fourth IGBT 44b in order to change each of the semiconductor switches between the conductive state and the interrupted state. The control signals Cs are respectively input to an AND circuit 91a to an AND circuit 91d. The outputs of the AND circuit 91a to the AND circuit 91d are respectively connected to the first IGBT 41b to the fourth IGBT 44b.

The other inputs of the AND circuit 91a to the AND circuit 91d are respectively values inverted from the outputs of an OR circuit 94a to an OR circuit 94d (described later). Each of the outputs of the OR circuit 94a to the OR circuit 94d is “1” when interruption process (described later) is being executed, and is “0” when the interruption process is not being executed.

Therefore, when the interruption process is not being executed, each of the first IGBT 41b to the fourth IGBT 44b is controlled by the corresponding control signal Cs that is output from the CPU. On the other hand, when the interruption process is being executed, all the first IGBT 41b to the fourth IGBT 44b are kept in the interrupted state irrespective of the control signals Cs that are generated by the CPU.

Each of the first overcurrent detection unit 41c to the fourth overcurrent detection unit 44c outputs a detection signal when current flowing through a corresponding one of the semiconductor switches exceeds a predetermined threshold. That is, an output value is “1”. The outputs of the first overcurrent detection unit 41c and third overcurrent detection unit 43c are input to the OR circuit 92a. The outputs of the second overcurrent detection unit 42c and fourth overcurrent detection unit 44c are input to the OR circuit 92b.

The output of the OR circuit 92a is input to the AND circuit 93a, and is input to an input port Pia of the CPU. The output of the OR circuit 92b is input to the AND circuit 93b, and is input to an input port Pib of the CPU. The other input of the AND circuit 93a is a signal RG1 that is output from an output port Poa of the CPU. The other input of the AND circuit 93b is a signal PG2 that is output from an output port Pob of the CPU. The CPU controls each of the signal RG1 and the signal RG2 to “1” except when interruption cancellation control (described later) is executed.

The output of the OR circuit 92a is also referred to as first overcurrent signal FCV1. When the output of the OR circuit 92a is “1”, it is also referred to as that the first overcurrent signal FCV1 is “1” or the first overcurrent signal FCV1 is output. The output of the OR circuit 92b is also referred to as second overcurrent signal FCV2. When the output of the OR circuit 92b is “1”, it is also referred to as that the second overcurrent signal FCV2 is “1” or the second overcurrent signal FCV2 is output.

The signal RG1 and the signal RG2 are also referred to as interruption process cancellation signals for the sake of convenience. Specifically, when the signal RG1 and/or the signal RG2 is “0”, it is also referred to as that the interruption process cancellation signal is output.

The output of the AND circuit 93a is connected to each of the OR circuit 94a to the OR circuit 94d. The other input of each of the OR circuit 94a to the OR circuit 94d is the output of the AND circuit 93b.

### Example of Occurrence of Overcurrent

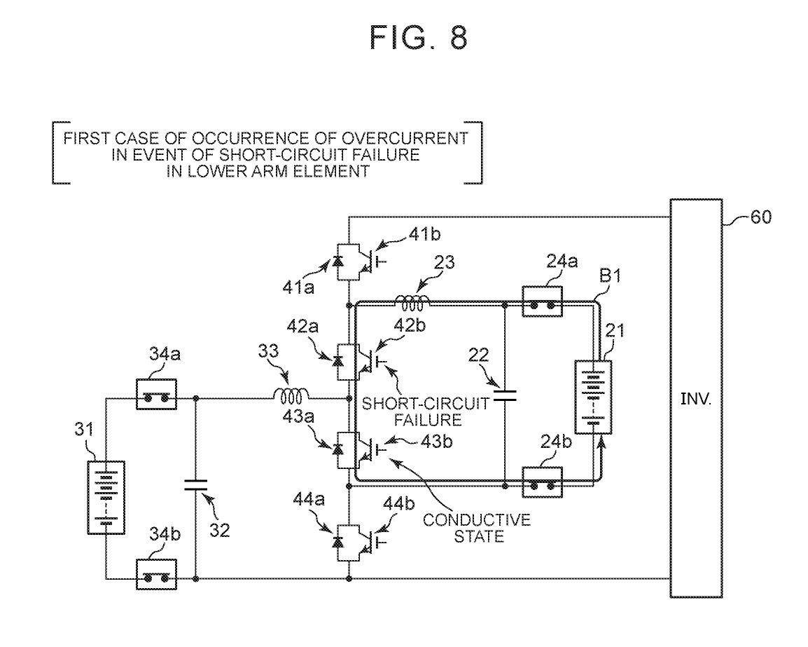

For example, when the third IGBT 43b is controlled to the conductive state in the case where there is a short-circuit failure in the second IGBT 42b, a closed circuit from the first storage battery 21 via the second IGBT 42b and the third IGBT 43b to the first storage battery 21 is established. This closed circuit is indicated by the wide line B1 in FIG. 8. When current flowing through the closed circuit becomes excessive, the third IGBT 43b and the first storage battery 21 may be damaged.

When current flowing through the closed circuit becomes excessive, the second overcurrent detection unit 42c and/or the third overcurrent detection unit 43c can detect occurrence of an overcurrent. When the second overcurrent detection unit 42c detects overcurrent, the output of the OR circuit 92b becomes “1”, that is, the first overcurrent signal FCV1 is output from the chip set 54 to the CPU. On the other hand, when the third overcurrent detection unit 43c detects overcurrent, the output of the OR circuit 92a becomes “1”, that is, the second overcurrent signal FCV2 is output from the chip set 54 to the CPU.

If there occurs a failure in one of the second overcurrent detection unit 42c and the third overcurrent detection unit 43c or one of the OR circuit 92a and the OR circuit 92b as a result of occurrence of an overcurrent, one of the first overcurrent signal FCV1 and the second overcurrent signal FCV2 is output to the CPU. The closed circuit indicated by the wide line B1 includes the lower arm elements (that is, the second IGBT 42b and the third IGBT 43b) of the step-up chopper circuit that causes energy to be stored in the first reactor 23, so the closed circuit is also referred to as lower arm loop. In other words, with the configuration of the chip set 54, even when there occurs a failure in one of the overcurrent detection units, the CPU is able to detect overcurrent that occurs in the lower arm loop for the first reactor 23.

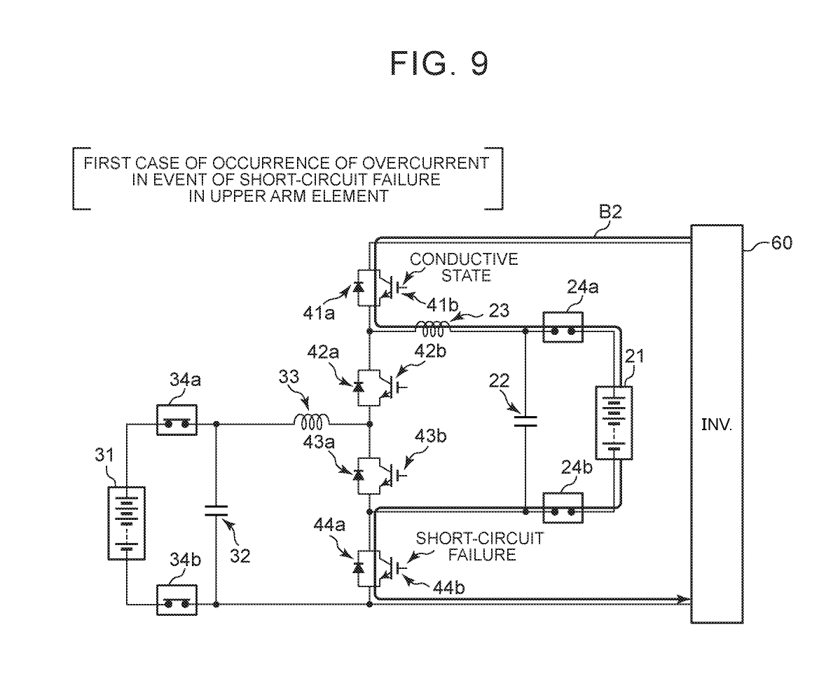

Alternatively, when the first IGBT 41b is controlled to the conductive state in the case where there is a short-circuit failure in the fourth IGBT 44b, a closed circuit from the inverter 60 via the first IGBT 41b, the first storage battery 21 and the fourth IGBT 44b to the inverter 60 is established. The closed circuit is indicated by the wide line B2 shown in FIG. 9. When current flowing through the closed circuit becomes excessive, the first IGBT 41b and the first storage battery 21 may be damaged.

When current flowing through the closed circuit becomes excessive, the first overcurrent detection unit 41c and/or the fourth overcurrent detection unit 44c can detect occurrence of an overcurrent. When the first overcurrent detection unit 41c detects overcurrent, the output of the OR circuit 92a becomes “1”, that is, the first overcurrent signal FCV1 is output from the chip set 54 to the CPU. On the other hand, when the fourth overcurrent detection unit 44c detects overcurrent, the output of the OR circuit 92b becomes “1”, that is, the second overcurrent signal FCV2 is output from the chip set 54 to the CPU.

If there occurs a failure in one of the first overcurrent detection unit 41c and the fourth overcurrent detection unit 44c or one of the OR circuit 92a and the OR circuit 92b as a result of occurrence of an overcurrent, one of the first overcurrent signal FCV1 and the second overcurrent signal FCV2 is output to the CPU. The closed circuit indicated by the wide line B2 includes the upper arm elements (that is, the first IGBT 41b and the fourth IGBT 44b) of the step-down chopper circuit that causes energy to be stored in the first reactor 23, so the closed circuit is also referred to as upper arm loop. In other words, with the configuration of the chip set 54, even when there occurs a failure in one of the overcurrent detection units, the CPU is able to detect overcurrent that occurs in the upper arm loop for the first reactor 23.

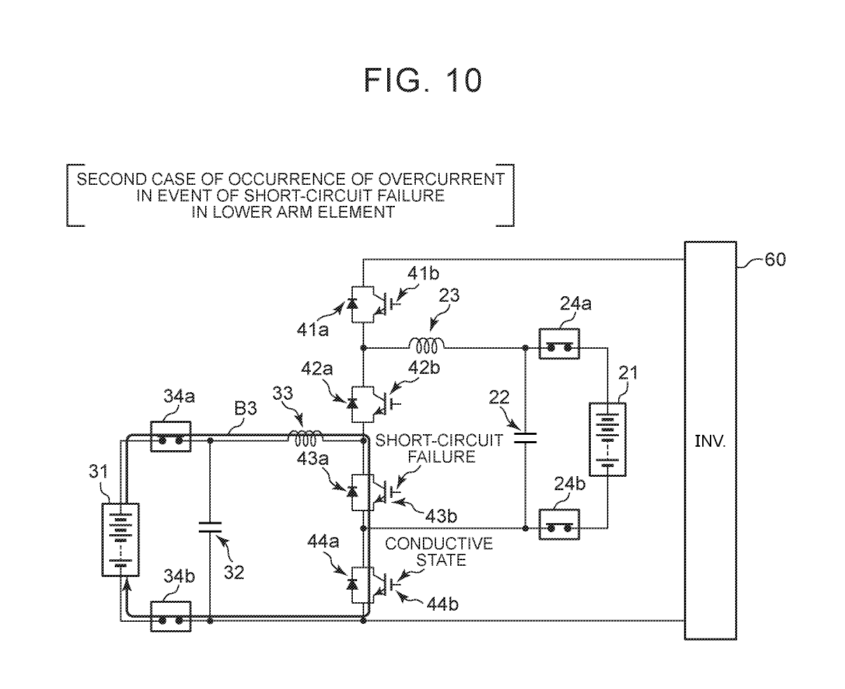

Alternatively, when the fourth IGBT 44b is controlled to the conductive state in the case where there is a short-circuit failure in the third IGBT 43b, a closed circuit from the second storage battery 31 via the third IGBT 43b and the fourth IGBT 44b to the second storage battery 31 is established. This closed circuit is indicated by the wide line B3 in FIG. 10. When current flowing through the closed circuit becomes excessive, the fourth IGBT 44b and the second storage battery 31 may be damaged.

When current flowing through the closed circuit becomes excessive, the third overcurrent detection unit 43c and/or the fourth overcurrent detection unit 44c can detect occurrence of an overcurrent. When the third overcurrent detection unit 43c detects overcurrent, the output of the OR circuit 92a becomes “1”, that is, the first overcurrent signal FCV1 is output from the chip set 54 to the CPU. On the other hand, when the fourth overcurrent detection unit 44c detects overcurrent, the output of the OR circuit 92b becomes “1”, that is, the second overcurrent signal FCV2 is output from the chip set 54 to the CPU.

If there occurs a failure in one of the third overcurrent detection unit 43c and the fourth overcurrent detection unit 44c or one of the OR circuit 92a and the OR circuit 92b as a result of occurrence of an overcurrent, one of the first overcurrent signal FCV1 and the second overcurrent signal FCV2 is output to the CPU. The closed circuit indicated by the wide line B3 includes the lower arm elements (that is, the third IGBT 43b and the fourth IGBT 44b) of the step-up chopper circuit that causes energy to be stored in the second reactor 33, so the closed circuit is also referred to as lower arm loop. In other words, with the configuration of the chip set 54, even when there occurs a failure in one of the overcurrent detection units, the CPU is able to detect overcurrent that occurs in the lower arm loop for the second reactor 33.

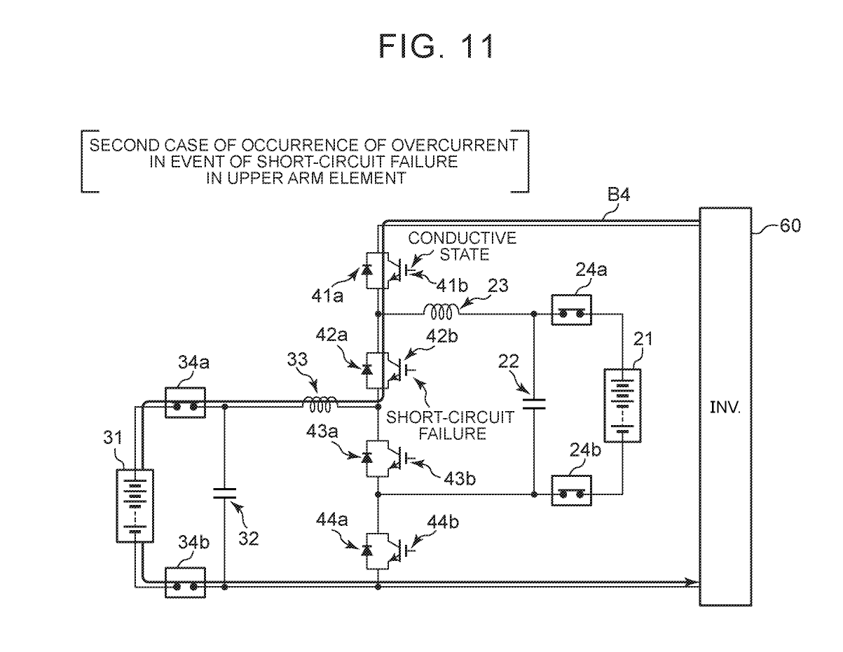

Alternatively, when the first IGBT 41b is controlled to the conductive state in the case where there is a short-circuit failure in the second IGBT 42b, a closed circuit from the inverter 60 via the first IGBT 41b, the second IGBT 42b and the second storage battery 31 to the inverter 60 is established. This closed circuit is indicated by the wide line B4 in FIG. 11. When current flowing through the closed circuit becomes excessive, the first IGBT 41b and the second storage battery 31 may be damaged.

When current flowing through the closed circuit becomes excessive, the first overcurrent detection unit 41c and/or the second overcurrent detection unit 42c can detect occurrence of an overcurrent. When the first overcurrent detection unit 41c detects overcurrent, the output of the OR circuit 92a becomes “1”, that is, the first overcurrent signal FCV1 is output from the chip set 54 to the CPU. On the other hand, when the second overcurrent detection unit 42c detects overcurrent, the output of the OR circuit 92b becomes “1”, that is, the second overcurrent signal FCV2 is output from the chip set 54 to the CPU.

If there occurs a failure in one of the first overcurrent detection unit 41c and the second overcurrent detection unit 42c or one of the OR circuit 92a and the OR circuit 92b as a result of occurrence of an overcurrent, one of the first overcurrent signal FCV1 and the second overcurrent signal FCV2 is output to the CPU. The closed circuit indicated by the wide line B4 includes the upper arm elements (that is, the first IGBT 41b and the second IGBT 42b) of the step-up chopper circuit that causes energy to be stored in the second reactor 33, so the closed circuit is also referred to as upper arm loop. In other words, with the configuration of the chip set 54, even when there occurs a failure in one of the overcurrent detection units, the CPU is able to detect overcurrent that occurs in the upper arm loop for the second reactor 33.

### Interruption Process in Event of Occurrence of Overcurrent

As described above, when there occurs an overcurrent, the interruption process for controlling the first IGBT 41b to the fourth IGBT 44b to the interrupted state is executed. More specifically, when the output of at least one of the first overcurrent detection unit 41c to the fourth overcurrent detection unit 44c becomes “1”, the first overcurrent signal FCV1 and/or the second overcurrent signal FCV2 becomes “1”. At this time, when interruption cancellation control is not executed, the interruption process cancellation signals (that is, the signal RG1 and the signal RG2) are “1”, so the output of the AND circuit 93a and/or the AND circuit 93b becomes “1”.

As a result, the outputs of the OR circuit 94a to the OR circuit 94d become “1”, so all the outputs of the AND circuit 91a to the AND circuit 91d become “0”. That is, irrespective of the control signals Cs that are output from the CPU, the outputs of the AND circuit 91a to the AND circuit 91d become “0”. Thus, the first IGBT 41b to the fourth IGBT 44b are controlled to the interrupted state. In other words, the interruption process is executed.

When the interruption process is executed, the above-described lower arm loop or upper arm loop is cancelled, so the overcurrent is eliminated. As a result, when the outputs of all the first overcurrent detection unit 41c to the fourth overcurrent detection unit 44c become “0”, the outputs of the OR circuit 94a to the OR circuit 94d become “1”, so the first IGBT 41b to the fourth IGBT 44b are controlled in accordance with the control signals Cs. That is, execution of the interruption process is stopped.

### Execution of Degenerate Operation

The CPU is able to detect occurrence of an overcurrent on the basis of the first overcurrent signal FCV1 and/or the second overcurrent signal FCV2, which is received from the chip set 54. When there occurs an overcurrent, there is a high possibility that there is a short-circuit failure in any one of the first IGBT 41b to the fourth IGBT 44b. Therefore, the CPU starts the degenerate operation of the vehicle 1. Specifically, the CPU controls the first system main relay 24 to the interrupted state, and controls the first IGBT 41b and the second IGBT 42b to the conductive state.

### Interruption Process in Event of Occurrence of Overcurrent

Incidentally, there is a case where any one of the first overcurrent detection unit 41c to the fourth overcurrent detection unit 44c fails as a result of occurrence of an overcurrent and, as a result, the failed overcurrent detection unit continues to output the detection signal. In this case, the above-described interruption process is continued, so it is impossible to execute the above-described degenerate operation. Specifically, it is not possible to control the first IGBT 41b and the second IGBT 42b to the conductive state.

When the first overcurrent signal FCV1 and/or the second overcurrent signal FCV2 has been “1” continuously for a predetermined time or longer, the CPU determines that there is a failure in any one of the first overcurrent detection unit 41c to the fourth overcurrent detection unit 44c. At this time, the CPU executes interruption cancellation control for forcibly stopping execution of the above-described interruption process.

More specifically, when the first overcurrent signal FCV1 and/or the second overcurrent signal FCV2 has been “1” continuously for the predetermined time or longer, the CPU changes the signal RG1 and the signal RG2 from “1” to “0”. As a result, the outputs of the AND circuit 93a and AND circuit 93b become “0”, so the outputs of the OR circuit 94a to OR circuit 94d become “0”. Therefore, each of the first IGBT 41b to the fourth IGBT 44b is controlled in accordance with the control signal Cs that is output from the CPU. That is, execution of the interruption process is stopped.

### Specific Operation

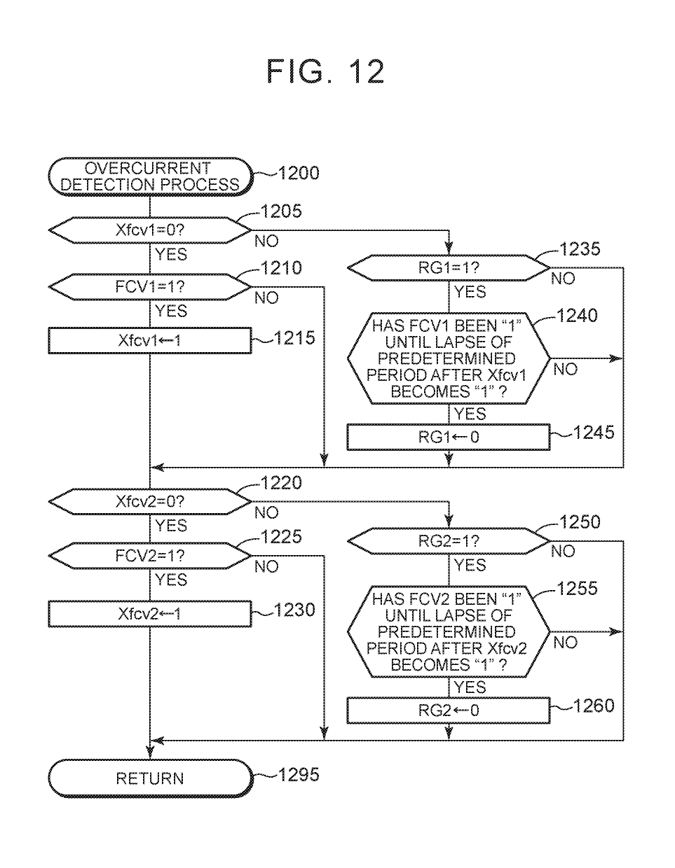

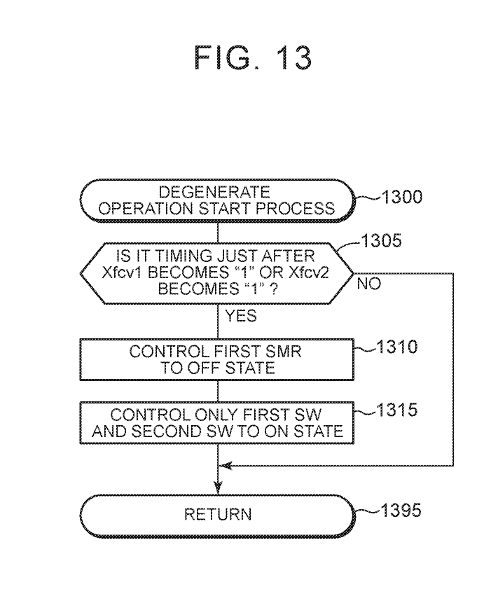

The specific operation of the CPU in executing the interruption process in the event of occurrence of an overcurrent will be described with reference to the overcurrent detection process routine shown by the flowchart in FIG. 12 and the degenerate operation start process routine shown by the flowchart in FIG. 13. The CPU executes these routines each time a predetermined time elapses.

That is, at adequate timing, the CPU starts the process from step 1200, proceeds to step 1205, and determines whether the value of a first overcurrent detection flag Xfcv1 is “0”. The value of the first overcurrent detection flag Xfcv1 is set to “0” in an initial routine (not shown) that is executed by the CPU. The initial routine is executed at a startup of the vehicle 1. In addition, through this initial routine, the value of a second overcurrent detection flag Xfcv2 (described later) is set to “0”, and the signal RG1 and the signal RG2 are set to “1”.

(A) when there is No Overcurrent

In this case, the value of the first overcurrent detection flag Xfcv is “0”, so the CPU makes affirmative determination in step 1205, proceeds to step 1210, and determines whether the first overcurrent signal FCV1 is “1”. There is no overcurrent at this point in time, so the first overcurrent signal FCV1 is “0”. Therefore, the CPU makes negative determination in step 1210, proceeds to step 1220, and determines whether the value of the second overcurrent detection flag Xfcv2 is “0”.

In this case, the value of the second overcurrent detection flag Xfcv2 is “0”, so the CPU makes affirmative determination in step 1220, proceeds to step 1225, and determines whether the second overcurrent signal FCV2 is “1”. There is no overcurrent at this point in time, so the second overcurrent signal FCV2 is “0”. Therefore, the CPU makes negative determination in step 1225, proceeds to step 1295, and once ends the routine.

On the other hand, at adequate timing, the CPU starts the process from step 1300, and proceeds to step 1305. In step 1305, the CPU determines whether it is the timing just after the value of the first overcurrent detection flag Xfcv1 is changed from “0” to “1” or the timing just after the value of the second overcurrent detection flag Xfcv2 is changed from “0” to “1”. The values of these flags are “0” at this point in time, so the CPU makes negative determination in step 1305, proceeds to step 1395, and once ends the routine.

(B) Just after Occurrence of Overcurrent in First IGBT 41b or Third IGBT 43b

In this case, the first overcurrent signal FCV1 becomes “1”, so the CPU makes affirmative determination in step 1210, proceeds to step 1215, and sets the value of the first overcurrent detection flag Xfcv to “1”. Subsequently, the CPU proceeds to step 1220.

When the CPU executes the routine of FIG. 12 again, the CPU makes negative determination in step 1205, proceeds to step 1235, and determines whether the signal RG1 that is output from the CPU is “1”. As described above, the signal RG1 is “1”, so the CPU makes affirmative determination in step 1235, and proceeds to step 1240.

In step 1240, the CPU determines whether the first overcurrent signal FCV1 has been “1” until a lapse of a predetermined time after the value of the first overcurrent detection flag Xfcv1 is changed to “1”. It is the timing just after the value of the first overcurrent detection flag Xfcv1 is changed to “1” at this point in time, so the predetermined time has not elapsed. Therefore, the CPU makes negative determination in step 1240 and proceeds to step 1220.

On the other hand, when the CPU executes step 1305 in FIG. 13 for the first time after the value of the first overcurrent detection flag Xfcv1 is changed to “1”, the CPU makes affirmative determination, proceeds to step 1310, and controls the first system main relay 24 to the interrupted state. Subsequently, the CPU proceeds to step 1315, controls the first IGBT 41b and the second IGBT 42b to the conductive state, and controls the third IGBT 43b and the fourth IGBT 44b to the interrupted state. In other words, the CPU sets the control signals Cs corresponding to the first IGBT 41b and the second IGBT 42b to “1”, and sets the control signals Cs corresponding to the third IGBT 43b and the fourth IGBT 44b to “0”. Subsequently, the CPU proceeds to step 1395. That is, in this case, the degenerate operation is started.

Thus, the vehicle 1 is able to continue traveling in a state where only the direct-current power supply that is output from the second storage battery 31 to the inverter 60 is supplied. On the other hand, when the electric motor 70 operates as a generator, current flows into the second storage battery 31 via the first IGBT 41b and the second IGBT 42b by using direct-current voltage that is generated between the positive electrode connection point (P3) and the negative electrode connection point (N3). Thus, it is possible to charge the second storage battery 31. However, when occurrence of an overcurrent is continuing, the above-described interruption process continues to be executed, so the first IGBT 41b and the second IGBT 42b are in the interrupted state. Therefore, the second storage battery 31 is not charged. Stopping the interruption process (interruption cancellation control) in the case where occurrence of an overcurrent is continuing will be described later.

(C) Just after Occurrence of Overcurrent in Second IGBT 42b or Fourth IGBT 44b

In this case, the second overcurrent signal FCV2 becomes “1”, so the CPU makes affirmative determination in step 1225, proceeds to step 1230, and sets the value of the second overcurrent detection flag Xfcv2 to “1”. Subsequently, the CPU proceeds to step 1295.

When the CPU executes the routine of FIG. 12 again, the CPU makes negative determination in step 1220, proceeds to step 1250, and determines whether the signal RG2 that is output from the CPU is “1”. As described above, the signal RG2 is “1”, so the CPU makes affirmative determination in step 1250, and proceeds to step 1255.

In step 1255, the CPU determines whether the second overcurrent signal FCV2 has been “1” until a lapse of the predetermined time after the value of the second overcurrent detection flag Xfcv2 is changed to “1”. It is the timing just after the value of the second overcurrent detection flag Xfcv2 is changed to “1”, so the predetermined time has not elapsed. Therefore, the CPU makes negative determination in step 1255, and proceeds to step 1295.

In this case as well, as well as the case of the above-described (B), the above-described degenerate operation is started when the flowchart of FIG. 13 is executed for the first time thereafter.

(D) when Occurrence of Overcurrent Continues

In this case, in the case where the first overcurrent signal FCV1 has been “1” until a lapse of the predetermined time after the value of the first overcurrent detection flag Xfcv1 is changed to “1”, when the routine of FIG. 12 is executed for the first time thereafter, the CPU makes affirmative determination in step 1240 and proceeds to step 1245. In step 1245, the CPU changes the output signal RG1 to “0”. Subsequently, the CPU proceeds to step 1220. That is, in this case, even when the first overcurrent signal FCV1 has been “1”, the interruption process is stopped.

Similarly, in the case where the second overcurrent signal FCV2 has been “1” until a lapse of the predetermined time after the value of the second overcurrent detection flag Xfcv2 is changed to “1”, when the routine of FIG. 12 is executed for the first time thereafter, the CPU makes affirmative determination in step 1255, and proceeds to step 1260. In step 1260, the CPU changes the output signal RG2 to “0”. Subsequently, the CPU proceeds to step 1295. That is, in this case, even when the second overcurrent signal FCV2 has been “1”, the interruption process is stopped.

As described above, the system (power supply system 10) includes a positive electrode connection point (P3), a negative electrode connection point (N3), a specific power supply line (FR), a first direct-current power supply (first storage battery 21), a second direct-current power supply (second storage battery 31), a first diode (41a), a second diode (42a), a third diode (43a), a fourth diode (44a), a first semiconductor switch (first IGBT 41b), a second semiconductor switch (second IGBT 42b), a third semiconductor switch (third IGBT 43b), a fourth semiconductor switch (fourth IGBT 44b), and a control unit (ECU 50). A load circuit (inverter 60) is connected to the positive electrode connection point and the negative electrode connection point. The positive electrode connection point and the negative electrode connection point are used to supply direct-current power to the load circuit. The specific power supply line connects the positive electrode connection point with the negative electrode connection point. The specific power supply line includes a first connection point (C1), a second connection point (C2), a third connection point (C3) and a fourth connection point (C4). The first connection point is located between the positive electrode connection point and the negative electrode connection point. The second connection point is located between the first connection point and the negative electrode connection point. The third connection point is located between the second connection point and the negative electrode connection point. The fourth connection point is located between the third connection point and the negative electrode connection point. A positive electrode of the first direct-current power supply is connected to the first connection point, and a negative electrode of the first direct-current power supply is connected to the third connection point. A positive electrode of the second direct-current power supply is connected to the second connection point, and a negative electrode of the second direct-current power supply is connected to the fourth connection point. The first diode is interposed in a portion of the specific power supply line between the positive electrode connection point and the first connection point. A cathode of the first diode is on the positive electrode connection point side, and an anode of the first diode is on the first connection point side. The second diode is interposed in a portion of the specific power supply line between the first connection point and the second connection point. A cathode of the second diode is on the first connection point, and an anode of the second diode is on the second connection point side. The third diode is interposed in a portion of the specific power supply line between the second connection point and the third connection point. A cathode of the third diode is on the second connection point side, and an anode of the third diode is on the third connection point side. The fourth diode is interposed in a portion of the specific power supply line between the third connection point and the fourth connection point. A cathode of the fourth diode is on the third connection point side, and an anode of the fourth diode is on the fourth connection point side. The first semiconductor switch is connected in antiparallel with the first diode. The second semiconductor switch is connected in antiparallel with the second diode. The third semiconductor switch is connected in antiparallel with the third diode. The fourth semiconductor switch is connected in antiparallel with the fourth diode. The control unit selectively executes any one of a parallel connection mode (FIG. 4 and FIG. 5) and a series connection mode (FIG. 6) by changing each of the first semiconductor switch to the fourth semiconductor switch between a conductive state and an interrupted state. In the parallel connection mode, the first direct-current power supply and the second direct-current power supply are connected to the load circuit in parallel with each other. In the series connection mode, the first direct-current power supply and the second direct-current power supply are connected to the load circuit in series with each other. In addition, the control unit steps up a terminal voltage (voltage V1) of the first direct-current power supply and/or a terminal voltage (voltage V2) of the second direct-current power supply and then applies the stepped-up voltage between the positive electrode connection point and the negative electrode connection point, or steps down a voltage between the positive electrode connection point and the negative electrode connection point and then applies the stepped-down voltage to the first direct-current power supply and/or the second direct-current power supply. The first semiconductor switch to the fourth semiconductor switch respectively include overcurrent detection units (first overcurrent detection unit 41c to fourth overcurrent detection unit 44c), each of which outputs a detection signal when the corresponding overcurrent detection unit has detected overcurrent flowing therethrough. The control unit includes an arithmetic processing unit (CPU 51) and a logic circuit unit (chip set 54). The arithmetic processing unit generates control signals for respectively changing the first semiconductor switch to the fourth semiconductor switch between the conductive state and the interrupted state. The logic circuit unit transmits the control signals to the first semiconductor switch to the fourth semiconductor switch, and receives the detection signals from the first semiconductor switch to the fourth semiconductor switch. The logic circuit unit outputs a first overcurrent signal (FCV1) to the arithmetic processing unit (input port Pia) when the logic circuit unit has received the detection signal from the first semiconductor switch and/or the third semiconductor switch (OR circuit 92a). The logic circuit unit outputs a second overcurrent signal (FCV2) to the arithmetic processing unit (input port Pib) when the logic circuit unit has received the detection signal from the second semiconductor switch and/or the fourth semiconductor switch (OR circuit 92b). When the CPU is receiving the detection signal from at least one of the first semiconductor switch to the fourth semiconductor switch, the control unit executes interruption process for keeping each of the first semiconductor switch to the fourth semiconductor switch in the interrupted state irrespective of the control signals (AND circuit 91a to AND circuit 91d, AND circuit 93a and AND circuit 93b, and OR circuit 94a to OR circuit 94d).

The arithmetic processing unit is configured to, when the arithmetic processing unit has received the first overcurrent signal and/or the second overcurrent signal (step 1240 and step 1255 in FIG. 12) continuously for a predetermined period, output an interruption process cancellation signal (the signal RG1 and the signal RG2 that are “0”) to the logic circuit unit (step 1245 and step 1260 in FIG. 12). The logic circuit unit is configured to, when the logic circuit unit is receiving the interruption process cancellation signal from the arithmetic process unit (the signal RG1 and/or the signal RG2 is “0”), stop the interruption process (AND circuit 93a and AND circuit 93b).

With the system, the number of input ports of the CPU that is used to detect occurrence of an overcurrent may be not four and may be suppressed to two. On the other hand, with the system, it is possible to detect overcurrent that occurs in the lower arm loop and the upper arm loop for the first reactor 23 and overcurrent that occurs in the lower arm loop and the upper arm loop for the second reactor 33. In addition, when there is an overcurrent, the system controls each of the first IGBT 41b to the fourth IGBT 44b to the interrupted state (that is, executes the interruption process), thus making it possible to eliminate the overcurrent.

With the system, even when any one of the first overcurrent detection unit 41c to the fourth overcurrent detection unit 44c continues to output a detection signal, it is possible to resume control over the first IGBT 41b to the fourth IGBT 44b (that is, stop the interruption process). Therefore, with the system, it is possible to reliably execute degenerate operation.

The embodiment of the power supply system according to the invention is described above; however, the invention is not limited to the above-described embodiment. The invention may be variously modified without departing from the scope of the invention. For example, the invention encompasses not only a power supply system for a vehicle, which is applied to a vehicle on which an electric motor is mounted as a driving force source, but also to a power supply system that is applied to a vehicle on which an internal combustion engine is further mounted as a driving force source (that is, a hybrid vehicle).

The chip set 54 according to the present embodiment is the integrated circuit including logic-arithmetic circuits, such as the AND circuits and the OR circuits. However, the chip set 54 may be formed of a combination of a plurality of semiconductor elements or may be formed of an integrated circuit that allows configuration change (for example, field-programmable gate array (FPGA)). The chip set 54 may be implemented by a program that is executed by a general-purpose computer.

The CPU 51 according to the present embodiment usually sets the signal RG1 and the signal RG2 to “1”, and sets the signal RG1 and/or the signal RG2 to “0” when the interruption cancellation control is executed. However, the CPU 51 may usually set the signal RG1 and the signal RG2 to “0”, and may set the signal RG1 and/or the signal RG2 to “1” when the interruption cancellation control is executed. In this case, a NOT circuit is inserted between the output port Poa of the CPU 51 and the AND circuit 93a and is also inserted between the output port Pob of the CPU 51 and the AND circuit 93b.

The ECU 50 according to the present embodiment drives the vehicle 1 by using direct-current power that is output from the second storage battery 31 when degenerate operation is executed. However, the ECU 50 may drive the vehicle 1 by using direct-current power that is output from the first storage battery 21. Specifically, the ECU 50 controls the second system main relay 34 to the interrupted state and controls only the first IGBT 41b and the fourth IGBT 44b to the conductive state when degenerate operation is executed. Alternatively, when there is an overcurrent, the ECU 50 may diagnose whether there is a short-circuit failure in any one of the first IGBT 41b to the fourth IGBT 44b and then determine degenerate operation to be executed on the basis of the diagnosed result.

In the present embodiment, the first storage battery 21 and the second storage battery 31 are lithium ion batteries. However, the first storage battery 21 and/or the second storage battery 31 may be a chargeable and dischargeable direct-current power supply of type different from a nickel-metal hydride battery, an electric double-layer capacitor and a lithium ion battery, such as a lithium ion capacitor.

In the present embodiment, the switch unit 40 includes the first IGBT 41b to the fourth IGBT 44b as the semiconductor switches. However, the switch unit 40 may include MOSFETs, GTO thyristors, and the like, as the semiconductor switches.

What is claimed is:

1. A power supply system comprising:
a positive electrode connection point and a negative electrode connection point to which a load circuit is connected, the positive electrode connection point and the negative electrode connection point being used to supply direct-current power to the load circuit;
a specific power supply line that connects the positive electrode connection point with the negative electrode connection point, the specific power supply line including a first connection point located between the positive electrode connection point and the negative electrode connection point, a second connection point located between the first connection point and the negative electrode connection point, a third connection point located between the second connection point and the negative electrode connection point, and a fourth connection point located between the third connection point and the negative electrode connection point;
a first direct-current power supply of which a positive electrode is connected to the first connection point and a negative electrode is connected to the third connection point;
a second direct-current power supply of which a positive electrode is connected to the second connection point and a negative electrode is connected to the fourth connection point;
a first diode interposed in a portion of the specific power supply line between the positive electrode connection point and the first connection point, a cathode of the first diode being on the positive electrode connection point side, and an anode of the first diode being on the first connection point side;
a second diode interposed in a portion of the specific power supply line between the first connection point and the second connection point, a cathode of the second diode being on the first connection point side, and an anode of the second diode being on the second connection point side;
a third diode interposed in a portion of the specific power supply line between the second connection point and the third connection point, a cathode of the third diode being on the second connection point side, and an anode of the third diode being on the third connection point side;
a fourth diode interposed in a portion of the specific power supply line between the third connection point and the fourth connection point, a cathode of the fourth diode being on the third connection point side, and an anode of the fourth diode being on the fourth connection point side;
a first semiconductor switch connected in antiparallel with the first diode;
a second semiconductor switch connected in antiparallel with the second diode;
a third semiconductor switch connected in antiparallel with the third diode;
a fourth semiconductor switch connected in antiparallel with the fourth diode; and
an electronic control unit configured to selectively execute any one of a parallel connection mode and a series connection mode by changing each of the first semiconductor switch to the fourth semiconductor switch between a conductive state and an interrupted state, the parallel connection mode being a mode in which the first direct-current power supply and the second direct-current power supply are connected to the load circuit in parallel with each other, the series connection mode being a mode in which the first direct-current power supply and the second direct-current power supply are connected to the load circuit in series with each other, the electronic control unit being configured to step up a terminal voltage of the first direct-current power supply or the second direct-current power supply and then apply the stepped-up voltage between the positive electrode connection point and the negative electrode connection point, or step down a voltage between the positive electrode connection point and the negative electrode connection point and then apply the stepped-down voltage to the first direct-current power supply or the second direct-current power supply, wherein
each of the first semiconductor switch to the fourth semiconductor switch includes an overcurrent detection unit configured to output a detection signal when the overcurrent detection unit has detected overcurrent flowing through a corresponding one of the first semiconductor switch to the fourth semiconductor switch,
the electronic control unit includes an arithmetic processing unit and a logic circuit unit, the arithmetic processing unit being configured to generate a control signal for changing each of the first semiconductor switch to the fourth semiconductor switch between the conductive state and the interrupted state, the logic circuit unit being configured to transmit the control signals to the first semiconductor switch to the fourth semiconductor switch and receive the detection signals from the first semiconductor switch to the fourth semiconductor switch, and
the logic circuit unit is configured to, when the logic circuit unit has received the detection signal from the first semiconductor switch or the third semiconductor switch, output a first overcurrent signal to the arithmetic processing unit, the logic circuit unit is configured to, when the logic circuit unit has received the detection signal from the second semiconductor switch or the fourth semiconductor switch, output a second overcurrent signal to the arithmetic processing unit, and the logic circuit unit is configured to, when the logic circuit unit is receiving the detection signal from at least one of the first semiconductor switch to the fourth semiconductor switch, execute interruption process for keeping each of the first semiconductor switch to the fourth semiconductor switch in the interrupted state irrespective of the control signal.

2. The power supply system according to claim 1, wherein
the arithmetic processing unit is configured to, when the arithmetic processing unit has received the first overcurrent signal or the second overcurrent signal continuously for a predetermined period, output an interruption process cancellation signal to the logic circuit unit, and
the logic circuit unit is configured to, when the logic circuit unit is receiving the interruption process cancellation signal from the arithmetic processing unit, stop the interruption process.
